(19) United States
(12) Patent Application Publication
(10) Pub. No.: US 2021/0127860 A1
(43) Pub. Date: May 6, 2021

(54) REUSABLE SHOPPING BAG DEVICES

(71) Applicant: Jesse Roper, Hawthorne, CA (US)

(72) Inventor: Jesse Roper, Hawthorne, CA (US)

(21) Appl. No.: 16/675,591

(22) Filed: Nov. 6, 2019

(51) Int. Cl. A47F 13/00; A45C 3/04; F16B 2/22; F16B 1/00

(52) U.S. Cl. CPC A47F 13/00; A45C 3/04; F16B 2001/0035; F16B 1/00; F16B 2/22

(57) ABSTRACT

A shopping bag suspension and storage device comprising a clip and suspension rod for suspending a reusable shopping bag.

### FIELD OF THE INVENTION

The present invention relates to shopping bags and more particularly to reusable shopping bags.

### BACKGROUND

Shoppers have long used plastic bags which are topically discarded after a single use. The problem with the plastic shopping bags has been long known. Plastic bags are manufactured from fossil fuels and end up as waste in landfills and on the ocean floor. Birds, fish, turtles, and other animals often intentionally or unintentionally ingest plastic bags or the remnants thereof, a characteristic which can transfer up the food chain to bigger fish and marine mammals.

It has been said that Americans use 100 million plastic bags per year manufactured from some 12 million barrels of oil. The average American family takes home almost 1,500 plastic shopping bags per year and published data suggests that only about 1% are recycled. Some 80% of ocean plastic pollution enters from land each year affecting hundreds of different species resulting in the death of some 100,000 marine animals. It will take more than 500 years for each plastic bag to degrade in a landfill, even then, the bags do not break down completely. The problem with plastic bags has become so acute that some municipalities have banned certain disposable bags and in some municipalities stores are required to charge consumers a deposit on each disposable bag.

In recognition of the problem, numerous different styles of disposable bags have been proposed over the years.

One of the drawbacks of disposable bags is the fact that special attention must be given to a construction which will provide for the mouth of the bag to remain open. One such construction proposed includes a hem around the upper portion of the sidewalls of the bag to act as a stiffening member. Construction of this type is disclosed in U.S. Pat. No. 9,604,757 to Spivack. Such bags, while offering benefits, have the drawback that manufacture with a stiffening hem adds to the expense of manufacture and, in practice, such hems often fail to afford the degree of rigidity necessary for maintaining the mouths of such bags open during the filling operation.

Single-use plastic packaging is a mounting problem, both environmentally and economically. This packaging fills our stores and ruminants are in our clothing which sheds microplastic fibers in the wash.

Published data indicates that in this century more plastic was made than in history up to the year 2000. Every year billions of pounds of more plastic end up in the world's oceans. Studies estimate that there are now 15-51 trillion pieces of plastic in the world's oceans. It is believed that not a single square mile of the ocean anywhere is free of plastic pollution. The fossil fuel industry indicates it plans to increase plastic production by 40% over the next decade. Oil giants are rapidly building petrochemical plants across the nation to turn fracking gas into the plastic. This means more plastic in our oceans.

Plastic is durable. The EPA reports that every bit of plastic ever made still exists. All five of the earth's major ocean gyres are inundated with plastic pollution as demonstrated by the Great Pacific Garbage Patch.

It is understood that fish in the North Pacific ingest 12,000 to 24,000 tons of plastic each year.

A published study found that a quarter of fish at markets in California contained plastic in their intestines mostly in the form of plastic microfibers. Sea birds ingest plastic every day. Plastic ingestion reduces the storage volume of the stomach causing starvation. It is estimated that 60% of the seabird species have eaten pieces of plastic.

Various nations have sought to tackle the problem and the US Environmental Protection Agency has asked the government to regulate plastics as a pollutant under the Clean Water Act.

Thus, there exists a critical demand for reusable plastic bags.

### SUMMARY OF THE INVENTION

The present invention includes a clamp for suspending a reusable flexible container bag from a shopping cart or the like and incorporates a horizontal rod attachable to the top of the container bag to hold the bag wall distended for convenient access to folded shopping bags contained in the container bag.

### DESCRIPTION OF PRIOR ART

It has been proposed to mount a pair of parallel arms cantileverally from a wall, spaced apart for receipt of clips which might clip to the opposite end walls of a bag. A device of this type is shown in U.S. Pat. No. 2,875,970 to Gardner. While beneficial for static applications, the separate arms and clip arrangement shown would not perform well for mounting disposable bags from a sidewall of a shopping cart.

It has also been proposed to provide the hooks or loops for suspending a bag from the side of a shopping cart. A device of this type is shown in U.S. Publication No. 2010/0320246 to Taylor. This device fails to provide firm or rigid support to hold the top of a flexible container bag open for convenient use in storing and deploying reusable shopping bags.

It has been known to provide a container for multiple shopping bags to be deployed from a folded position as disclosed in U.S. Pat. No. 5,046,860 to Brennan and U.S. Pat. No. 5,182,895 to Lugo. While providing containment for folded shopping bags, such devices fail to incorporate acceptable structure for suspending a flexible shopping bag container from a shopping cart in such a way as to maintain the container bag in an open orientation for convenient access to folded reusable shopping bags contained therein.

### BRIEF DESCRIPTION OF THE DRAWINGS

FIG. 1 is a perspective view of a reusable shopper bag hanger device incorporated present invention;

FIG. 2 is a front view thereof, partially cut away;

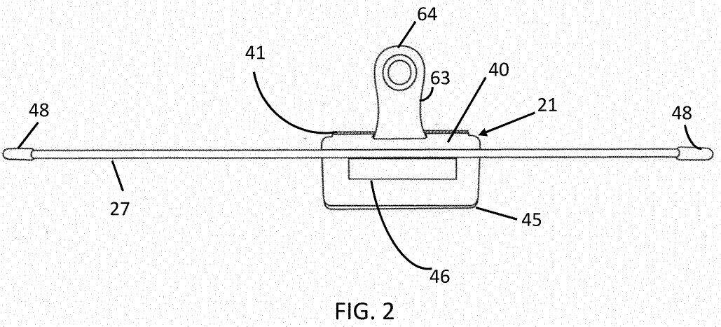

FIG. 3 is a perspective view, in reduced scale, of the device of FIG. 1 suspended from a shopping cart; and

FIG. 4 is a top perspective view, in an enlarged scale of the device shown in FIG. 3.

### DETAILED DESCRIPTION OF THE PREFERRED EMBODIMENTS

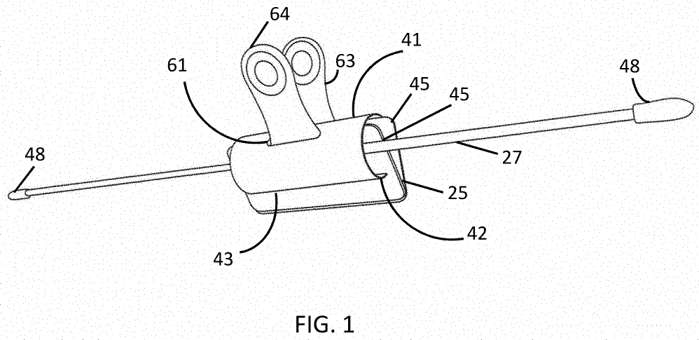

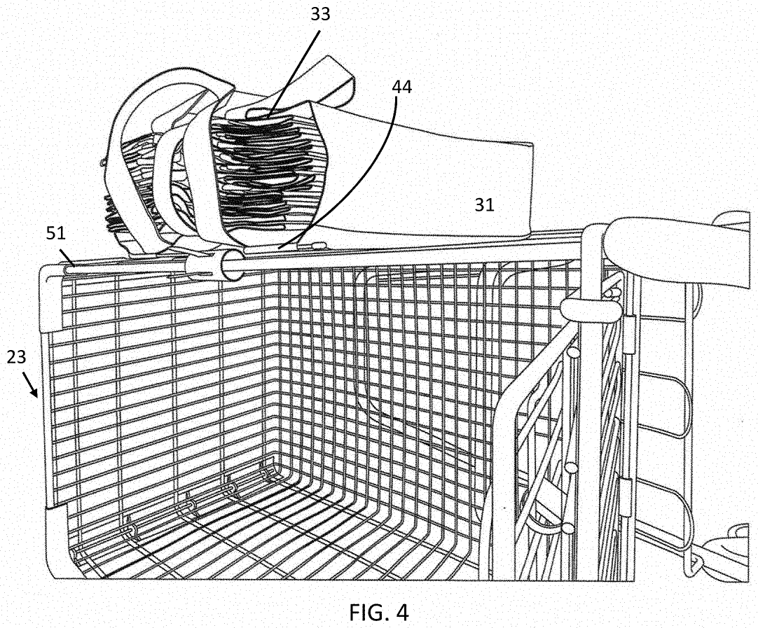

Referring to FIGS. 1 and 4, the reusable shopping cart hanger device of the present invention includes, generally, a clip device 21 for clipping to the side of a shopping cart 23. The clip device includes a clip 25 carrying a horizontally projecting rigid hanger rod 27 for suspension of a flexible shopping container bag 31 containing a plurality of folded flexible reusable shopping bags 33 for ready access by a shopper. The proximal wall of the container bag is formed along its upper edge with a pair of spaced apart horizontal sleeves 44 (FIG. 4) for receiving the opposite lengths of the rod 27

The demand for a device for carrying and presenting reusable shopping bags for ready use has long existed. Busy consumers on a grocery shopping trip have little time to locate and arrange shopping bags for ready use and in a manner that will encourage reuse thereof. It is thus important that a device for housing and dispensing reusable shopping bags to a busy shopper be convenient to use, convenient to load, and constructed for ready presentation and deployment of numerous shopping bags which might be needed during a grocery shopping trip. It is this objective to which the present invention is directed.

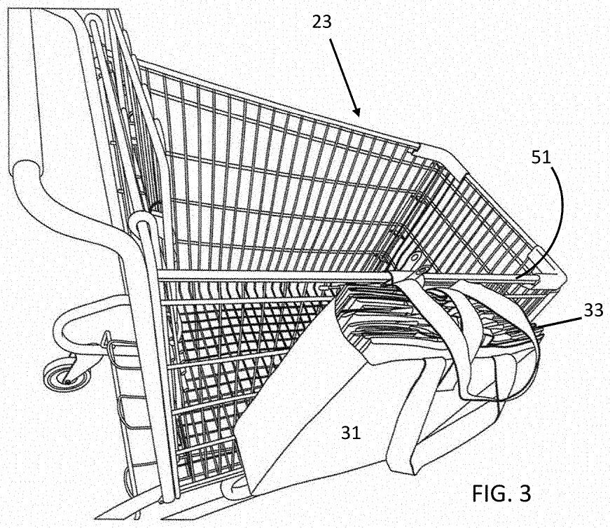

In my preferred embodiment, I incorporate a spring clip device 21 including an elongated split cylindrical spring barrel 41 open along one side to terminate opposite longitudinal, confronting edges 43 which press radially inwardly against the medial outside surfaces of respective rectangular clamp plates 45 to press the distal edges thereof together for clamping over an item such as the top bar 51 of a shopping cart 23 (FIG. 3). The plates 45 are affixed to the clip edges 43 by glue 42 (FIG. 1) or similar fastening material. The back edges 40 of the plates abut the back wall of the barrel to be partially supported thereby.

The barrel 41 is formed in its backside with cylindrically spaced apart, parallel slots 61 through which respective elongated divergent cars 63 project to form pressure 64 for access by the operator. The convergent ends of the cars 63 within the barrel 41 carry the respective plates 45 for, upon relax of the barrel 41, press the distal edges of the plates together. In my preferred embodiment, I incorporate cushioning caps 48 in the opposite ends of the rod 27.

For my preferred embodiment, I selected a barrel, pressure plates, and rod all of ferromagnetic material and select a magnet 46 with a rectangular beam like construction to fit in the space outside the pressure plate 45 and within the barrel such that the magnet forms a magnetic field around the barrel, pressure plate, and rod thereby maintaining the magnet and rod in their selected positions for convenient adjustment and support of reusable bags hung from the rod. My work has proven that the described construction is economical to manufacture and performs well in practice.

In operation, it will be appreciated that the shopper may conveniently carry the suspension device and the container bag 31 into the store, a shopping cart 23 may be retrieved and the device over the top rail 51 of the cart 23 (FIG. 3). With the device so suspended and the opposite extremities of the rod 27 received in the respective bag sleeves 44 (FIG. 4) the proximal wall of the bag 31 will be suspended in a vertical plane along the side of the sidewall of the cart 23 to allow the distal wall of such container bag to deploy outwardly and expose the contained bags 33 for ready access as the shopper moves about the store collecting items for purchase.

Grocery items selected may be selectively placed in the selected reusable bags and the loaded bags place in the hold of the shopping cart for presentation at the check-out counter. As the items are retrieved and checked by the cashier or by the customer, they may be placed back in the respective bags to be conveniently transported by a cart or otherwise to the shopper's automobile trunk or other automobile space. The bags may be then be placed in the trunk or backseat and the shopping cart returned to the return area.

Upon arriving home, the respective bags 33 filled with groceries may be transported to the kitchen or pantry area for unloading. As the respective bags are unloaded, they may be again folded in accordion fashion and placed back in the container bag 31 to be stored for subsequent use in the next trip to the grocery store.

From the foregoing, it will be apparent that the reusable shopping bag apparatus for the present invention is economical to manufacture, convenient to use, and will serve to attract ready and convenient use by everyday shoppers to encourage.

1. Reusable shopping bag and suspension apparatus comprising:
a clip for clipping to the side of a shopping cart;
an elongated suspension rod supported by the clip and extending horizontally from the opposite sides thereof;
a flexible container bag suspended from the rod;
a clip;
a magnet in the clip for generating a magnetic field around the suspension rod; and
a plurality of folded flexible reusable bags supported in the container bag.

2. (canceled)

3. The apparatus of claim 1 wherein:
the suspension rod includes opposite extremities; and
caps received on the opposite extremities.

4.-9. (canceled)
